(19) United States
(12) Patent Application Publication
(10) Pub. No.: US 2020/0387600 A1
(43) Pub. Date: Dec. 10, 2020

(54) ATTACK DEFENSE METHOD AND APPARATUS FOR TERMINAL, TERMINAL, AND CLOUD SERVER

(71) Applicant: HUAWEI TECHNOLOGIES CO., LTD., Shenzhen (CN)

(72) Inventors: Zhi KANG, Hangzhou (CN); Yang XU, Hangzhou (CN); Yingliang YAO, Beijing (CN); Zhuochen WANG, Beijing (CN)

(73) Assignee: HUAWEI TECHNOLOGIES CO., LTD., Shenzhen (CN)

(21) Appl. No.: 17/003,173

(22) Filed: Aug. 26, 2020

Related U.S. Application Data
(63) Continuation of application No. PCT/CN2019/103044, filed on Aug. 28, 2019.

(30) Foreign Application Priority Data
Oct. 12, 2018 (CN) 201811188595.2

(51) Int. Cl. G06F 21/53; G06F 21/55; G06F 21/57

(52) U.S. Cl. CPC G06F 21/53; G06F 21/577; G06F 21/554

(57) ABSTRACT

An attack defense method and apparatus for a terminal, a terminal, and a cloud server. Before a client application (CA) communicates with a secure application (TA), a secure execution environment such as a trusted execution environment (TEE) verifies scenario feature information, such as screen touch information, corresponding to a current operation of the client application, to determine whether the operation is an actual operation of a user or a hacker attack. If the operation is a hacker attack, there is no screen touch information. If there is a risk of a hacker attack, communication between the client application and the secure application is not established, so that the client application cannot run properly, and an attempt initiated by a hacker to discover a system vulnerability is blocked.

### CROSS-REFERENCE TO RELATED APPLICATIONS

This application is a continuation of International Application No. PCT/CN2019/103044, filed on Aug. 28, 2019, which claims priority to Chinese Patent 201811188595.2, filed on Oct. 12, 2018. The disclosures of the aforementioned applications are hereby incorporated by reference in their entireties.

### TECHNICAL FIELD

The embodiments relate to computer technologies, and in particular, to an attack defense technology and a plurality of computer devices to which the attack defense technology is applied.

### BACKGROUND

A hacker attack, in short, is a technology by which a hacker discovers defects of a terminal system or a network, and uses these defects to implement an attack. The defects herein include a software defect, a hardware defect, a network protocol defect, a management defect, and the like.

In a conventional technology, there are usually the following several methods for defending against a hacker attack. In an address space layout randomization (ASLR) defense method shown in FIG. 1, an original memory address on a stack is randomized by using a random address generator; when discovering one stack overflow vulnerability, a hacker searches for an address of a corresponding stack and implants hacker code; however, after a terminal is restarted, the stack address changes, and a hacker attack fails. In a control flow integrity (CFI) defense method shown in FIG. 2, a running program is parsed; during program running, an indirect transfer instruction executed by the program is compared with a preobtained indirect transfer instruction whitelist; if the indirect transfer instruction obtained through parsing is not in the whitelist, it is determined that an attack occurs, and the program running is terminated. In a stack canary based defense method shown in FIG. 3, a canary is preset on an initial stack for checking, and after a hacker discovers a stack overflow vulnerability and implants hacker code, the canary changes. Before a program runs, the canary is checked to prevent execution of the hacker malicious code.

However, before implementing an actual attack, a hacker usually needs repeated attempts on a terminal system to discover a system vulnerability, and the hacker attacks the terminal system based on the discovered system vulnerability. However, the foregoing conventional hacker attack defense methods are all direct defense performed after a hacker discovers a system vulnerability and performs a malicious attack, and cannot prevent repeated attempts made by a hacker in advance to discover a system vulnerability.

### SUMMARY

The embodiments provide an attack defense method and apparatus for a terminal, a terminal, and a cloud server, to resolve a problem that a conventional hacker attack defense method cannot prevent repeated attempts of a hacker to discover a system vulnerability.

According to a first aspect, the embodiments provide an attack defense method for a terminal. The method includes: a secure execution environment receives a communication request of a first client application for communication with a first secure application, where the secure execution environment includes either or both of a trusted execution environment (TEE) and a cloud security environment, and the communication request includes current first scenario feature information corresponding to the first client application. A scenario is any operation of any client application, and a client application name and a client application operation that correspond to each scenario are unique. The scenario feature information includes any one or more of the following information: terminal screen touch information, terminal screen status information, and client application running information, where the terminal screen touch information includes any one or more of the following information: a quantity of taps on a terminal screen, a touch location on the terminal screen, and a manner of touching the terminal screen when the client application is operated, the terminal screen status information includes any one or more of the following information: a terminal screen-on state and a terminal screen luminance value, and the client application running information is used to indicate whether the client application runs in the foreground. When verifying the first scenario feature information, the secure execution environment establishes communication between the first secure application and the first client application.

The secure execution environment determines whether the first scenario feature information is valid, for example, determines whether a prestored scenario feature information set includes second scenario feature information that matches the first scenario feature information, where the prestored scenario feature information set includes scenario feature information corresponding to all CAs. The first scenario feature information is considered valid if the prestored scenario feature information set includes the second scenario feature information that matches the first scenario feature information. If the first scenario feature information is verified, the secure execution environment establishes communication between the first secure application and the first client application.

In this implementation, when receiving a communication request of any client application for communication with a corresponding secure application, the secure execution environment obtains, from the communication request, current scenario feature information corresponding to the client application, and verifies whether the information is valid; if the information is invalid, it indicates that the client application is not operated by a user currently, there is a risk of a hacker attack, and communication between the client application and the secure application is not established, so that the client application cannot run properly, and an attempt initiated by a hacker to discover a system vulnerability is blocked. Determining whether the scenario feature information is valid can effectively avoid a hacker attack that is not performed by the user and effectively improve system security.

With reference to the first aspect, in a first possible implementation of the first aspect, that the secure execution environment performs verification on the first scenario feature information includes: determining, by the secure execution environment, whether the prestored scenario feature information set includes the second scenario feature information that matches the first scenario feature information, where the prestored scenario feature information set includes scenario feature information corresponding to a plurality of CAs and operations of the plurality of CAs.

With reference to the first possible implementation of the first aspect, in a second possible implementation of the first aspect, the determining, by the secure execution environment, whether the prestored scenario feature information set includes the second scenario feature information that matches the first scenario feature information includes: traversing the scenario feature information set to obtain the second scenario feature information corresponding to a client application name and a client application operation that are respectively the same as a client application name and a client application operation corresponding to the first scenario feature information; and determining whether the second scenario feature information is consistent with the first scenario feature information.

With reference to the first or the second possible implementation of the first aspect, in a third possible implementation of the first aspect, the method further includes: receiving, by the secure execution environment, scenario feature information update data from an REE side; and updating the scenario feature information set based on the scenario feature information update data.

According to a second aspect, the embodiments provide an attack defense method for a terminal, where an REE is deployed on the terminal. The method includes: sending, by the REE, a communication request of a first client application for communication with a first secure application, where the communication request includes current first scenario feature information corresponding to the first client application, where the scenario feature information includes any one or more of the following information: terminal screen touch information, terminal screen status information, and client application running information, where the terminal screen touch information includes any one or more of the following information: a quantity of taps on a terminal screen, a touch location on the terminal screen, and a manner of touching the terminal screen when the client application is operated, the terminal screen status information includes any one or more of the following information: a terminal screen-on state and a terminal screen luminance value, and the client application running information is used to indicate whether the client application runs in the foreground; and controlling a current operation of the first client application based on a status of communication between the first client application and the first secure application.

With reference to the second aspect, in a first possible implementation of the second aspect, the controlling a current operation of the first client application based on a status of communication between the first client application and the first secure application includes: if communication is established between the first client application and the first secure application, allowing the current operation of the first client application.

With reference to the second aspect or the first possible implementation of the second aspect, in a second possible implementation of the second aspect, the method further includes: receiving, by the REE, scenario feature information update data from a network side; and sending the scenario feature information update data to a secure execution environment.

According to a third aspect, the embodiments provide an attack defense apparatus for a terminal, where the apparatus includes: a receiving module, deployed in a secure execution environment and configured to receive a communication request of a first client application client application for communication with a first secure application secure application, where the secure execution environment includes either or both of a trusted execution environment TEE and a cloud security environment, and the communication request includes current first scenario feature information corresponding to the first client application, where the scenario feature information includes any one or more of the following information: terminal screen touch information, terminal screen status information, and client application running information, where the terminal screen touch information includes any one or more of the following information: a quantity of taps on a terminal screen, a touch location on the terminal screen, and a manner of touching the terminal screen when the client application is operated, the terminal screen status information includes any one or more of the following information: a terminal screen-on state and a terminal screen luminance value, and the client application running information is used to indicate whether the client application runs in the foreground; and a processing module, deployed in the secure execution environment and configured to: when verifying the first scenario feature information, establish communication between the first secure application and the first client application.

With reference to the third aspect, in a first possible implementation of the third aspect, the processing module includes: a determining unit, configured to determine whether a prestored scenario feature information set includes second scenario feature information that matches the first scenario feature information, where the prestored scenario feature information set includes scenario feature information corresponding to a plurality of CAs and operations of the plurality of CAs.

With reference to the first possible implementation of the third aspect, in a second possible implementation of the third aspect, the determining unit includes: an obtaining subunit, configured to traverse the scenario feature information set to obtain the second scenario feature information corresponding to a client application name and a client application operation that are respectively the same as a client application name and a client application operation corresponding to the first scenario feature information; and a determining subunit that determines whether the second scenario feature information obtained by the obtaining unit is consistent with the first scenario feature information.

With reference to the first or the second possible implementation of the third aspect, in a third possible implementation of the third aspect, the receiving module further includes: a receiving unit, configured to receive scenario feature information update data from a rich execution environment REE side deployed on the terminal; and an updating unit, configured to update the scenario feature information set based on the scenario feature information update data received by the receiving unit.

According to a fourth aspect, the embodiments provide a terminal. The terminal includes: a sending module, configured to send, by the REE, a communication request of a first client application for communication with a first secure application, where the communication request includes current first scenario feature information corresponding to the first client application, the scenario is any operation of any client application, and a client application name and a client application operation that correspond to each scenario are unique; and the scenario feature information includes any one or more of the following information: terminal screen touch information, terminal screen status information, and client application running information, where the terminal screen touch information includes: a quantity of taps on a terminal screen, a touch location on the terminal screen, and a manner of touching the terminal screen when the client application is operated, the terminal screen status information includes: a terminal screen-on state and a terminal screen luminance value, and the client application running information is used to indicate whether the client application runs in the foreground; and a control module, configured to control a current operation of the first client application based on a status of communication between the first client application and the first secure application.

With reference to the fourth aspect, in a first possible implementation of the fourth aspect, the control module includes: a control unit, configured to: if communication is established between the first client application and the first secure application, allow the current operation of the first client application.

With reference to the fourth aspect or the first possible implementation of the fourth aspect, in a second possible implementation of the fourth aspect, the terminal further includes: a receiving unit, configured to receive, by the REE, scenario feature information update data from a network side; and a sending unit, configured to send the scenario feature information update data to a secure execution environment.

According to a fifth aspect, the embodiments provide a terminal, where an REE and a TEE are deployed on the terminal. The terminal includes: a processor; and a memory, configured to store a computer-executable instruction; where when the processor executes the computer-executable instruction, the TEE performs the method according to any one of the first aspect and the possible implementations of the first aspect, and the REE performs the method according to any one of the second aspect and the possible implementations of the second aspect.

According to a sixth aspect, the embodiments provide a terminal, where an REE is deployed on the terminal. The terminal includes: a processor; and a memory, configured to store a computer-executable instruction; where when the processor executes the computer-executable instruction, the REE performs the method according to any one of the second aspect and the possible implementations of the second aspect.

According to a seventh aspect, an embodiment provides a cloud server, where the cloud server communicates with a terminal on which an REE is deployed. The cloud server includes: a cloud memory, configured to store an instruction program; and when the instruction program runs on the cloud server, a cloud security environment is generated, and the cloud security environment performs the method according to any one of the first aspect and the possible implementations of the first aspect.

According to an eighth aspect, the embodiments provide a computer storage medium, which may be non-volatile. The computer storage medium includes a computer program, and when the computer program is executed by one or more processors, the method according to any one of the foregoing aspects or implementations is implemented.

According to a ninth aspect, the embodiments provide a computer program or a computer program product. The computer program or the program product includes computer program instructions, and when the computer program is executed by one or more processors, the method according to any one of the foregoing aspects or implementations is implemented.

### BRIEF DESCRIPTION OF DRAWINGS

To describe the technical solutions of the embodiments more clearly, the following briefly describes the accompanying drawings required for describing the embodiments.

FIG. 1 is a schematic diagram of an ASLR defense method;

FIG. 2 is a schematic diagram of a CFI defense method;

FIG. 3 is a schematic diagram of a stack canary-based defense method;

FIG. 4 is an architectural diagram of a terminal system with REE-TEE deployment according to an embodiment;

FIG. 5 is a schematic flowchart of an attack defense method for a terminal according to an embodiment;

FIG. 6 is a schematic flowchart of another attack defense method for a terminal according to an embodiment;

FIG. 7 is a schematic structural diagram of an attack defense apparatus for a terminal according to an embodiment;

FIG. 8 is a schematic structural diagram of a terminal according to an embodiment;

FIG. 9 is a schematic structural diagram of a terminal according to an embodiment; and

FIG. 10 is a schematic diagram in which a cloud server communicates with a terminal according to an embodiment.

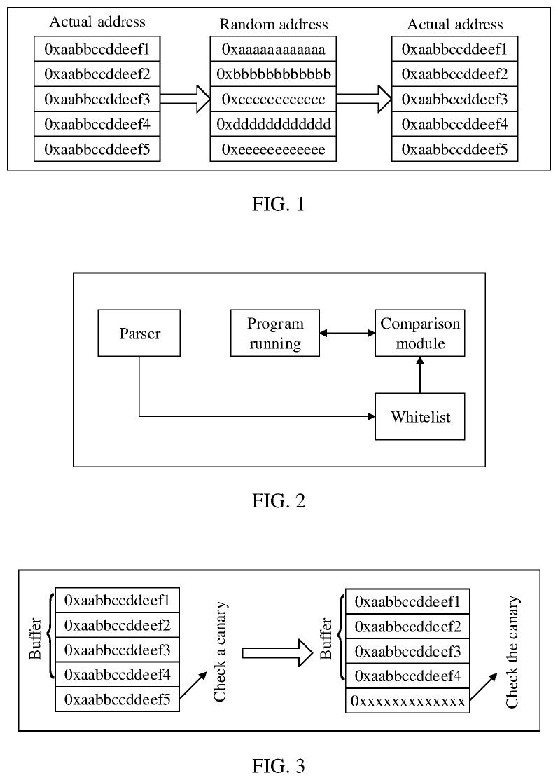

### DESCRIPTION OF EMBODIMENTS

To make a person of ordinary skill in the art better understand the technical solutions in the embodiments, the following further describes the technical solutions in the embodiments in detail with reference to the accompanying drawings.

To better describe the technical solutions provided in the embodiments, a secure execution environment and a rich execution environment (REE) are first described. The secure execution environment in the embodiments includes a trusted execution environment (TEE) and a cloud security environment. The REE is usually a general-purpose operating system execution environment, and an application program in the REE is a common client application client application. The cloud security environment is a virtual secure execution environment on a network side, and may be generated by using a security module or a security program. The TEE is an execution environment that may be deployed on a terminal and that has a higher security level than the REE. To ensure trustworthiness of the TEE, the TEE needs to be verified and be isolated from the REE during secure startup. The secure execution environment provides an authorized secure application, namely, a secure application secure application, and the secure execution environment protects confidentiality and integrity of and access permission for a resource and data of the secure application. In the secure execution environment, each secure application is independent of each other, and cannot access each other without authorization. In short, the secure execution environment has its own execution space, in the secure execution environment, there is a secure application corresponding to a client application in the REE, and each secure application in the TEE also needs to be authorized and run independently of each other.

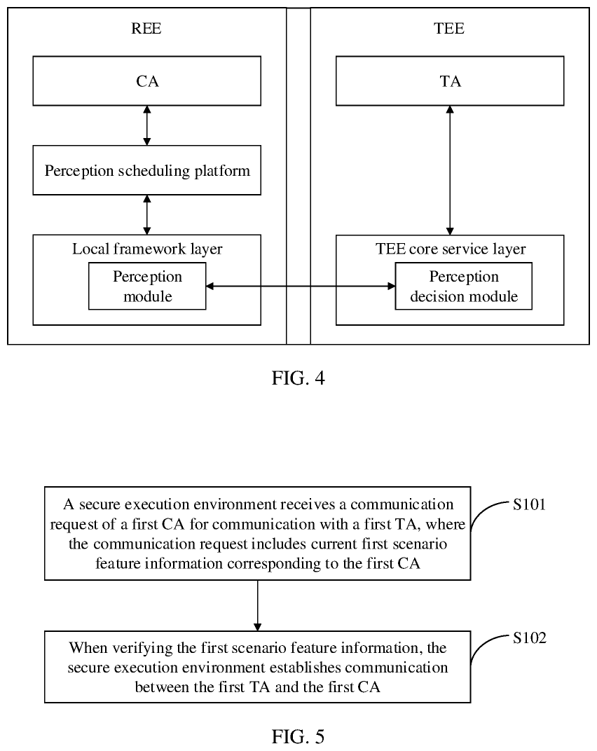

When the embodiments are based on a terminal system in which both the REE and the TEE are deployed, FIG. 4 is an architectural diagram of a terminal system with REE-TEE deployment according to an embodiment. An REE side includes a client application, a perception scheduling platform, and a local framework layer, where a perception module is disposed in the local framework layer. When the terminal is started, the perception scheduling platform collects terminal screen status information, terminal screen touch information, and client application running information. For example, the terminal screen status information includes: whether a screen is in an on state or an off state, whether a luminance value of the screen at a current moment is different from that at a previous moment, or the like. The terminal screen touch information is an operation performed on a terminal screen when a user normally operates a client application, and includes: a quantity of taps on the terminal screen, a touch location on the terminal screen, and a manner of touching the terminal screen such as a plurality of consecutive taps or long press on the terminal screen within a specific time. The client application running information is used to indicate whether the client application runs in the foreground.

After collecting the foregoing scenario feature information, the perception scheduling platform sends the scenario feature information to the perception module disposed in the local framework layer. The perception module encrypts and packetizes the received scenario feature information and sends encrypted and packetized scenario feature information to the TEE. For example, the TEE includes a secure application and a TEE core service layer. In this embodiment, a perception decision module is disposed in the TEE core service layer. The perception decision module receives the scenario feature information sent by the perception module in the REE, decompresses the received scenario feature information, and prestores decompressed scenario feature information in the TEE.

It can be noted that the foregoing architectural diagram of REE-TEE is merely an example. During actual platform implementation, more service components such as a drive component and an interface component are further required. Details are not described in this embodiment.

It can be understood from the foregoing description that the TEE has a secure application corresponding to a client application in the REE. When any client application on the REE side needs a secure operation during startup or running, the client application needs to request to establish communication with a corresponding secure application in the TEE. The REE allows the client application to properly run only after communication is successfully established between the client application and the secure application. However, not all communication requests are normal communication requests, and in a network environment, there may be a small quantity of communication requests generated by a hacker in a remote attempt. Therefore, only when it is ensured that an operation during startup or running of a client application is a user operation, it can be ensured that a current communication request is not generated under control of a hacker in a remote attempt. In view of this, an embodiment provides an attack defense method for a terminal. Referring to FIG. 5, the attack defense method for a terminal includes the following steps.

S101. A secure execution environment receives a communication request of a first client application for communication with a first secure application, where the communication request includes current first scenario feature information corresponding to the first client application.

The secure execution environment in this embodiment is a TEE. When the first client application in an REE is to start and run or is running, if a secure operation is required in the foregoing process, that is, support of the TEE is required, the first client application requests to communicate with the first secure application. The first secure application is a secure application that is in the TEE and that corresponds to the first client application. When the first client application requests to communicate with the first secure application, the REE does not simply send the communication request, but collects the first scenario feature information corresponding to the first CA. It can be understood from the foregoing description that, in the architecture of REE-TEE provided in this embodiment, there is a perception scheduling platform in the REE, and when the terminal is started, the perception scheduling platform collects scenario feature information corresponding to each client application in the REE. In this embodiment, when the first client application requests to communicate with the first secure application, the perception scheduling platform also collects the first scenario feature information corresponding to a current operation of the first client application. The first scenario feature information includes: corresponding terminal screen status information, terminal screen touch information, and running information of the first client application when the first client application is operated. The REE sends the collected first scenario feature information together with the communication request to the TEE, and the TEE receives the communication request sent by the REE and carrying the first scenario feature information.

It can be noted that the first scenario feature information in this embodiment may be one or more of the corresponding terminal screen status information, terminal screen touch information, and running information of the first client application when the first client application is operated. This is not limited in the description of the embodiments. In addition, a “scenario” corresponding to scenario feature information is a specific operation of a client application, for example, starting the client application, or entering a password during running of the client application. In addition, a client application name and a client application operation that correspond to scenario feature information in each specific scenario are also unique. For example, for starting a payment application A, the client application name is the payment application A, and the client application operation is starting. Therefore, scenario feature information that needs to be obtained in this case is: screen status information, terminal screen touch information, and running information of the payment application A that correspond to starting the payment application A, and may be any combination of the foregoing corresponding scenario feature information, including: the terminal screen touch information, a combination of the terminal screen status information and the terminal screen touch information, a combination of the terminal screen status information and the running information of the payment application A, a combination of the terminal screen touch information and the running information of the payment application A, or the like.

For example, the terminal screen status information includes: whether a screen is in an on state or an off state, whether a luminance value of the screen at a current moment is different from that at a previous moment, or the like. The terminal screen touch information is an operation performed on a terminal screen when a user normally operates a client application, and includes: a quantity of taps on the terminal screen, a touch location on the terminal screen, and a manner of touching the terminal screen such as a plurality of consecutive taps or long press on the terminal screen within a specific time. The client application running information is used to indicate whether the client application runs in the foreground. Therefore, the foregoing scenario feature information may be a combination of possible specific feature information included in each piece of scenario feature information. Still using starting the payment application A as an example, the scenario feature information corresponding to the payment application A may be: tapping the terminal screen once, tapping the middle of the terminal screen, the screen is in an on state, and only the payment application A runs in the foreground at a current moment. However, the foregoing description is merely an example, and there may be various possible combinations. For example, two or more taps may be required to start some CAs, a location of each tap is different, and luminance of the screen changes with each tap. Specific examples are not listed one by one.

S102. When verifying the first scenario feature information, the secure execution environment establishes communication between the first secure application and the first client application.

After receiving the communication request that is sent by the REE and is of the first client application for communication with the first secure application, the TEE parses the communication request to obtain the first scenario feature information carried in the communication request. Then, the TEE obtains a client application name of the first client application and a current operation of the first client application. The TEE traverses, based on the client application name and the client application operation of the first client application, a scenario feature information set prestored in the TEE, obtains second scenario feature information corresponding to a client application name and a client application operation that are respectively consistent with the client application name and the client application operation of the first client application, and compares the first scenario feature information with the second scenario feature information.

The scenario feature information set in this embodiment includes scenario feature information corresponding to different operations of all client applications in the REE, and the scenario feature information corresponding to the different operations is independent. For example, the scenario feature information set includes scenario feature information corresponding to an operation such as starting the payment application A, or entering a payment password, changing the payment password, or binding a mobile phone number after starting the payment application A, scenario feature information corresponding to starting an application B, registering user information on the application B, or modifying the user information on the application B, or scenario feature information corresponding to starting an application C, setting an unlock password for the application C, or changing the unlock password for the application C. All the foregoing feature information corresponds to the scenario feature information set corresponding to a database and is listed one by one, as shown in Table 1. The scenario feature information corresponding to the application A, the application B, the application C, and different operations of different applications shown in Table 1 is an example and is a part of implementation of the technical solutions of the embodiments.

TABLE 1
Database of the scenario feature information set

| Application | Application | Scenario feature |
|---|---|---|
| name | operation | information |
| Payment | Start | A screen is on, and the |
| application | | application runs in |
| A | | the foreground |
| Payment | Enter a | A screen is on, and tap |
| application | payment | the screen twice |
| A | password | |
| Payment | Change a | Two taps on a screen |
| application | payment | and corresponding |
| A | password | locations |
| Payment | Bind a | A screen is on, and |
| application | mobile | tap the screen |
| A | phone | three times |
| | number | |
| Application | Start | A screen is on, and the |
| B | | application runs in |
| | | the foreground |
| Application | Register user | A screen is on, and tap |
| B | information | the screen twice |
| Application | Modify user | A screen is on, and tap |
| B | information | the screen three times |
| Application | Start | A screen is on, and tap |
| C | | the screen once |
| Application | Set an | A screen is on; |
| C | unlock | screen pressing |
| | password | duration |
| Application | Change an | Three taps on a screen |
| C | unlock | and corresponding |
| | password | locations |

If a name of the first client application corresponding to the first scenario feature information is the payment application A, and an operation of the first client application is changing a payment password, the TEE traverses the scenario feature information set. If the TEE finds that a client application name and a client application operation that correspond to the second scenario feature information are respectively the payment application A and changing a payment password, the TEE compares the first scenario feature information with the second scenario feature information, to determine whether the first scenario feature information matches the second scenario feature information.

If the first scenario feature information matches the second scenario feature information, it indicates that the current operation corresponding to the first scenario feature information is performed by a user, and communication between the first secure application and the first client application is directly established.

For example, for changing a payment password on the payment application A, the second scenario feature information obtained by the TEE from the scenario feature information set and corresponding to the changing a payment password on the payment application A is: a screen is on, a luminance value of the screen changes during screen redirection, and tapping the screen twice sequentially at a first location and a second location. If the first scenario feature information is consistent with the second scenario feature information, it is determined that the current changing a payment password on the payment application A is a user operation. However, if the obtained first scenario feature information is: a screen is on and the screen redirects, it can be determined that the screen is on and the screen redirects under control of a hacker through remote simulation. In this case, communication between the payment application A and a secure application corresponding to the payment application A is not established.

In the foregoing description, the secure execution environment is the TEE. When the secure execution environment is a cloud security environment, steps of an attack defense method for a terminal are consistent with the foregoing steps. When the REE performs data transmission with the TEE, the data transmission can be implemented in the terminal. However, when the secure execution environment is a cloud security environment, and the REE performs data transmission with the cloud security environment, a network is required for transmission and communication. Therefore, in this case, a data channel for transmission and a signal for communication need to be encrypted, to ensure security of interaction between the REE and the cloud security environment.

It should be noted that the secure execution environment is not limited to the secure execution environment TEE and the remote security environment that are provided in the foregoing embodiments, and may alternatively be any other secure execution environment that can ensure a secure operation of a client application on a terminal.

A terminal may have a system update, addition of a new client application, or uninstallation of an existing client application that causes display locations of some client applications on a terminal screen to change. In this case, when a corresponding client application is controlled to start, a touch location changes. In particular, in a special case, if a hacker attack technology is upgraded, most client application operations can be remotely simulated. In this case, if the original scenario feature information remains unchanged, mistaken determining occurs in the secure execution environment, and an attempt of a hacker still cannot be effectively prevented. In this case, a step of a client application operation needs to be detailed. In conclusion, in this embodiment, the scenario feature information set in the secure execution environment is further updated.

A specific update of the scenario feature information may be a manual operation or autonomous machine learning. A specific manner is not limited in the embodiments. Scenario feature information update data may be sent to a cloud on a network side, and then be automatically obtained by a terminal or manually pushed. The REE deployed in the terminal first obtains the scenario feature update data, completes, based on the scenario feature update data, an update of the scenario feature corresponding to all CAs in the REE, and then sends the scenario update data to the secure execution environment. After receiving the scenario feature information update data, the secure execution environment updates the current scenario feature information set. When the secure execution environment is a cloud security environment, at the same time when the REE obtains the scenario feature update data, the scenario feature information update data may not need to be sent by the REE and may be directly obtained by the cloud security environment.

It can be understood from the foregoing embodiment that, in the attack defense method for a terminal provided in this embodiment, when receiving a communication request of any client application for communication with a corresponding secure application, the secure execution environment obtains, from the communication request, current scenario feature information corresponding to the client application, and verifies whether the information is valid; if the information is invalid, it indicates that the client application is not operated by a user currently, there is a risk of a hacker attack, and communication between the client application and the secure application is not established, so that the client application cannot run properly, and an attempt initiated by a hacker to discover a system vulnerability is blocked. Determining whether the scenario feature information is valid can effectively avoid a hacker attack that is not performed by the user and effectively improve system security.

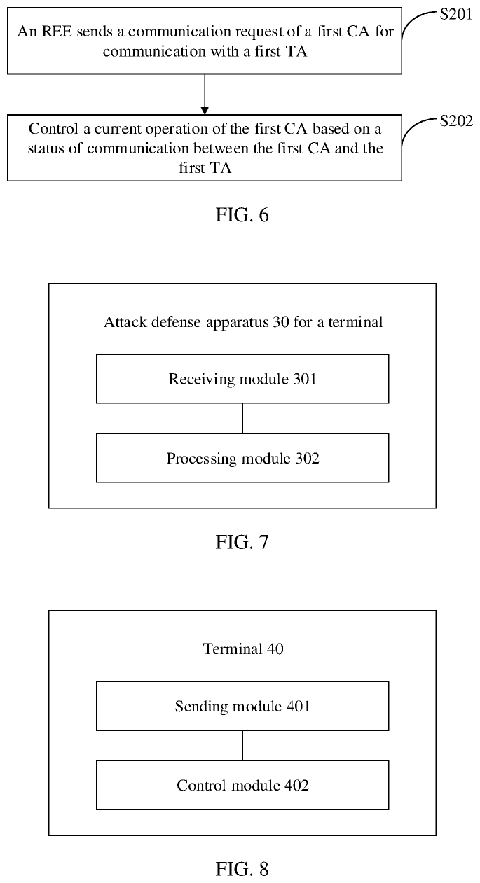

FIG. 6 shows another attack defense method for a terminal according to an embodiment. The attack defense method for a terminal includes the following steps.

S201. An REE sends a communication request of a first client application for communication with a first secure application, where the communication request includes current first scenario feature information corresponding to the first client application.

When the terminal is started, a perception scheduling platform in the REE collects scenario feature information corresponding to all CAs in the REE. The scenario feature information includes terminal screen status information, terminal screen touch information, and client application running information corresponding to different operations of different CAs. The terminal screen status information includes: whether a screen is in an on state or an off state, whether a luminance value of the screen at a current moment is different from that at a previous moment, or the like. The terminal screen touch information is an operation performed on a terminal screen when a user normally operates a client application, and includes: a quantity of taps on the terminal screen, a touch location on the terminal screen, and a manner of touching the terminal screen such as a plurality of consecutive taps or long press on the terminal screen within a specific time. The client application running information is used to indicate whether the client application runs in the foreground. The REE packetizes the collected scenario feature information corresponding to different operations of all CAs, and sends packetized scenario feature information to a secure execution environment.

When the first client application in the REE is to start and run or is running, if a secure operation is required during running, that is, support of the secure execution environment is required, the REE sends, to the secure execution environment, the communication request of the first client application for communication with the first secure application in the secure execution environment. When the first client application initiates the communication request, the REE does not simply send the communication request. In this case, the REE collects the first scenario feature information corresponding to the first client application. In this embodiment, at the same time when the first client application initiates the communication request, the perception scheduling platform also collects the first scenario feature information. The first scenario feature information includes: corresponding terminal screen status information, terminal screen touch information, and running information of the first client application when the first client application is operated. The REE packetizes the collected first scenario feature information and the communication request, and sends packetized first scenario feature information and communication request to the TEE.

S202. Control a current operation of the first client application based on a status of communication between the first client application and the first secure application.

If second scenario feature information corresponding to a client application name and a client application operation that are respectively consistent with a client application name and a client application operation that correspond to the first scenario feature information of the first client application is obtained by traversing a prestored scenario feature information set in the secure execution environment, and after the first scenario feature information is compared with the second scenario feature information, if the first scenario feature information matches the second scenario feature information, the secure execution environment establishes communication between the first client application and the first secure application. In this case, if the REE learns that communication is successfully established between the first client application and the first secure application, the current operation of the first client application is allowed. Correspondingly, if communication fails to be established between the first client application and the first secure application, the current operation of the first client application is an operation generated under remote control of a hacker, and the REE terminates current running of the first client application.

For example, for starting the payment application A, if communication is successfully established between the payment application A and a corresponding secure application in the secure execution environment, the payment application A is allowed to start. Otherwise, the payment application A directly crashes or is closed, and cannot be properly started. If a payment password change screen needs to be redirected to during running of the payment application A, and communication is successfully established between the payment application A and a corresponding secure application in the secure execution environment, the page is successfully redirected to, and the payment application A proceeds to a next operation. However, if communication fails to be established between the payment application A and the corresponding secure application in the secure execution environment, there may be a risk that a hacker remotely tampers with a user's payment password, the page fails to be redirected to, and the payment application A cannot proceed to an operation of changing the payment password. Alternatively, to avoid repeated remote control of a hacker, the payment application A is directly controlled to terminate running, so that the hacker cannot find the payment application A to perform a remote operation.

Similarly, a terminal may have a system update, addition of a new client application, or uninstallation of an existing client application that causes display locations of some CAs on a terminal screen to change. In this case, when a corresponding client application is controlled to start, a touch location changes. In particular, in a special case, if a hacker attack technology is upgraded, most client application operations can be remotely simulated. In this case, if the original scenario feature information remains unchanged, mistaken determining occurs in the secure execution environment, and an attempt of a hacker still cannot be effectively prevented. In this case, a step of a client application operation needs to be detailed, and the scenario feature information set in the secure execution environment needs to be updated.

A specific update of the scenario feature information may be a manual operation or autonomous machine learning. A specific manner is not limited in the embodiments. Scenario feature information update data may be sent to a cloud on a network side, and then be automatically obtained by a terminal or manually pushed. The REE first obtains the scenario feature update data, completes, based on the scenario feature update data, an update of the scenario feature corresponding to all client applications in the REE, and then sends the scenario update data to the secure execution environment. When the secure execution environment is a cloud security environment, at the same time when the REE obtains the scenario feature update data, the scenario feature information update data may not need to be sent by the REE and may be directly obtained by the cloud security environment.

It can be understood from the foregoing embodiment that, when the terminal is started, the REE collects the scenario feature information corresponding to all client applications, and sends the scenario feature information to the secure execution environment. When a client application in the REE is to properly start and run or is properly running, communication needs to be established between the client application and a corresponding secure application in the secure execution environment. When communication needs to be established between any client application in the REE and a corresponding secure application in the secure execution environment, the REE obtains current scenario feature information corresponding to the client application, and sends the current scenario feature information corresponding to the client application together with a communication request to the secure execution environment. If the secure execution environment cannot find matching scenario feature information in the scenario feature information set, it indicates that the client application is not operated by a user currently, there is a risk of a hacker attack, and communication between the client application and the secure application is not established, so that the client application cannot run properly, and an attempt initiated by a hacker to discover a system vulnerability is blocked. Determining whether the scenario feature information is valid can effectively avoid a hacker attack that is not performed by the user and effectively improve system security.

A further embodiment of an attack defense apparatus for a terminal corresponding to the attack defense method for a terminal may be shown in FIG. 5. Referring to FIG. 7, an attack defense apparatus 30 for a terminal includes: a receiving module 301 and a processing module 302.

The receiving module 301 is deployed in a secure execution environment and configured to receive a communication request of a first client application client application for communication with a first secure application secure application. The secure execution environment includes either or both of a trusted execution environment TEE and a cloud security environment. The communication request includes current first scenario feature information corresponding to the first client application. The scenario feature information includes any one or more of the following information: terminal screen touch information, terminal screen status information, and client application running information. The terminal screen touch information includes any one or more of the following information: a quantity of taps on a terminal screen, a touch location on the terminal screen, and a manner of touching the terminal screen when the client application is operated. The terminal screen status information includes any one or more of the following information: a terminal screen-on state and a terminal screen luminance value. The client application running information is used to indicate whether the client application runs in the foreground.

The processing module 302 is deployed in the secure execution environment and configured to: when verifying the first scenario feature information, establish communication between the first secure application and the first client application.

Optionally, the processing module 302 includes: a determining unit, configured to determine whether a prestored scenario feature information set includes second scenario feature information that matches the first scenario feature information, where the prestored scenario feature information set includes scenario feature information corresponding to a plurality of CAs and operations of the plurality of CAs.

The determining unit includes: an obtaining subunit and a determining subunit. The obtaining subunit is configured to traverse the scenario feature information set to obtain the second scenario feature information corresponding to a client application name and a client application operation that are respectively the same as a client application name and a client application operation corresponding to the first scenario feature information. The determining subunit is configured to determine whether the second scenario feature information obtained by the obtaining unit is consistent with the first scenario feature information.

Optionally, the receiving module 301 in this embodiment further includes a receiving unit and an updating unit. The receiving unit is configured to receive scenario feature information update data from a rich execution environment REE side deployed on the terminal. The updating unit is configured to update the scenario feature information set based on the scenario feature information update data received by the receiving unit.

There is further provided an embodiment of a terminal corresponding to the attack defense method for a terminal shown in FIG. 6. Referring to FIG. 8, a terminal 40 includes: a sending module 401 and a control module 402.

The sending module 401 is configured to send, by the REE, a communication request of a first client application for communication with a first secure application. The communication request includes current first scenario feature information corresponding to the first client application. The scenario is any operation of any client application, and a client application name and a client application operation that correspond to each scenario are unique. The scenario feature information includes any one or more of the following information: terminal screen touch information, terminal screen status information, and client application running information. The terminal screen touch information includes: a quantity of taps on a terminal screen, a touch location on the terminal screen, and a manner of touching the terminal screen when the client application is operated. The terminal screen status information includes: a terminal screen-on state and a terminal screen luminance value. The client application running information is used to indicate whether the client application runs in the foreground. The control module 402 is configured to control a current operation of the first client application based on a status of communication between the first client application and the first secure application.

Optionally, the control module 402 includes a control unit, configured to: if communication is established between the first client application and the first secure application, allow the current operation of the first client application.

Optionally, the terminal 40 for a terminal provided in this embodiment further includes: a receiving unit and a sending unit. The receiving unit is configured to receive, by the REE, scenario feature information update data from a network side. The sending unit is configured to send the scenario feature information update data to the receiving module 301 deployed in the secure execution environment.

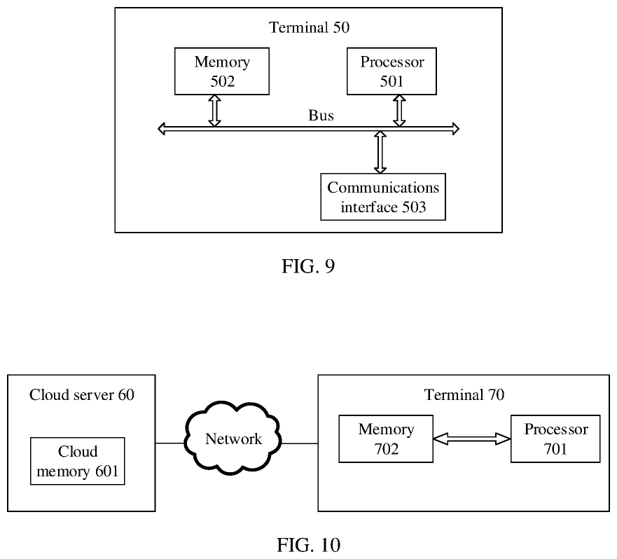

Referring to FIG. 9, an embodiment further provides a terminal. An REE and a TEE are deployed on a terminal 50, and the terminal 50 includes: a processor 501, a memory 502, and a communications interface 503.

The memory 502 is configured to store a computer-executable instruction. When the processor 501 executes the computer-executable instruction, the TEE performs the following operations: receiving a communication request of a first client application for communication with a first secure application, where the communication request includes current first scenario feature information corresponding to the first client application; determining whether a prestored scenario feature information set includes second scenario feature information that matches the first scenario feature information, where the prestored scenario feature information set includes scenario feature information corresponding to all client applications; and if the scenario feature information set includes the second scenario feature information that matches the first scenario feature information, establishing, by the TEE, communication between the first secure application and the first client application.

The REE performs the following operations: sending, by the REE, the communication request of the first client application for communication with the first secure application, where the communication request includes the current first scenario feature information corresponding to the first client application; and controlling a current operation of the first client application based on a status of communication between the first client application and the first secure application.

The processor 501, the memory 502, and the communications interface 503 may be interconnected by using a bus. The bus may be classified as an address bus, a data bus, a control bus, or the like. For ease of representation, only one thick line is used to represent the bus in FIG. 9, but this should not be interpreted to mean that there is only one bus or only one type of bus.

The processor 501 may be a general purpose processor, for example, a central processing unit (CPU), a network processor, or a combination of a CPU and a network processor. The processor 501 may alternatively be a microprocessor (microprocessor control unit or MCU). The processor 501 may further include a hardware chip. The hardware chip may be an application-specific integrated circuit (ASIC), a programmable logic device (PLD), or a combination thereof. The PLD may be a complex programmable logic device (CPLD), a field programmable gate array (FPGA), or the like.

The memory 502 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The communications interface 503 is configured to receive, by the REE, scenario feature information update data sent by a network side. The communications interface 503 includes a wired communications interface, or may include a wireless communications interface. The wired communications interface includes a data interface, or may include an Ethernet interface. The wireless communications interface may be a WLAN interface, a cellular network communications interface, a combination thereof, or the like.

The terminal 50 may further include a power supply component, configured to supply power to various components of the terminal 50. The power supply assembly may include a power management system and one or more power supplies. In specific implementation, an embodiment further provides a computer storage medium. The computer storage medium may store an instruction. When the instruction is executed, some or all of the steps in the embodiments of the attack defense methods for a terminal provided in the embodiments may be included. The storage medium may be a magnetic disk, an optical disc, a read-only memory (ROM), a random access memory (RAM), or the like.

Referring to FIG. 10, a cloud server 60 is provided. The cloud server 60 communicates with a terminal 70 on which an REE is deployed, and the cloud server 60 includes: a cloud memory 601, configured to store an instruction program.

When the instruction program runs on the cloud server 60, a cloud security environment is generated, and the cloud security environment performs the following steps: receiving a communication request of a first client application for communication with a first secure application, where the communication request includes current first scenario feature information corresponding to the first client application; determining whether a prestored scenario feature information set includes second scenario feature information that matches the first scenario feature information, where the prestored scenario feature information set includes scenario feature information corresponding to all CAs; and if the scenario feature information set includes the second scenario feature information that matches the first scenario feature information, establishing, by the cloud security environment, communication between the first secure application and the first client application.

The terminal 70 includes: a processor 701 and a memory 702. The memory 702 is configured to store a computer-executable instruction. When the processor 701 executes the computer-executable instruction, the REE performs the following steps: sending, by the REE, the communication request of the first client application for communication with the first secure application, where the communication request includes the current first scenario feature information corresponding to the first client application; and controlling a current operation of the first client application based on a status of communication between the first client application and the first secure application.

It can be noted that in the descriptions of the embodiments, relational terms such as “first” and “second” are used only to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or a device that includes a list of elements not only includes those elements but also includes other elements that are not expressly listed, or further includes elements inherent to such a process, method, article, or device. An element preceded by “includes a . . . ” does not, without more constraints, preclude the presence of additional identical elements in the process, method, article, or device that includes the element.

For same or similar parts in the embodiments herein, refer to each other. In particular, methods in embodiments of the apparatus, the terminal, and the cloud server are basically similar to embodiments of the attack defense methods for a terminal, and therefore are described briefly. For related parts, refer to descriptions in the embodiments of the attack defense methods for a terminal.

The foregoing descriptions are implementations of the embodiments, but are not intended to limit the protection scope.

What is claimed is:

1. An attack defense method for a terminal, the method comprising:
receiving, by a secure execution environment, a communication request of a first client application (CA) for communication with a first secure application (TA), wherein the secure execution environment comprises either or both of a trusted execution environment (TEE) and a cloud security environment, and the communication request comprises current first scenario feature information corresponding to the first CA;
the scenario feature information comprises any one or more of the following information: terminal screen touch information, terminal screen status information, and client application running information, wherein the terminal screen touch information comprises any one or more of the following information: a quantity of taps on a terminal screen, a touch location on the terminal screen, and a manner of touching the terminal screen when the client application is operated, the terminal screen status information comprises any one or more of the following information: a terminal screen-on state and a terminal screen luminance value, and the client application running information is used to indicate whether the client application runs in the foreground; and
establishing, when the secure execution environment verifies the first scenario feature information, by the secure execution environment, communication between the first secure application and the first client application.

2. The method according to claim 1, wherein that the secure execution environment performs verification on the first scenario feature information comprises: determining, by the secure execution environment, whether a prestored scenario feature information set comprises second scenario feature information that matches the first scenario feature information, and the prestored scenario feature information set comprises scenario feature information corresponding to a plurality of client applications and operations of the plurality of client applications.

3. The method according to claim 2, wherein the determining, by the secure execution environment, of whether a prestored scenario feature information set comprises second scenario feature information that matches the first scenario feature information comprises:
traversing the scenario feature information set to obtain the second scenario feature information corresponding to a client application name and a client application operation that are respectively the same as the first client application and a current operation of the first client application; and
determining whether the second scenario feature information is consistent with the first scenario feature information.

4. The method according to claim 2, further comprising:
receiving, by the secure execution environment, scenario feature information update data from a rich execution environment (REE) side; and
updating the scenario feature information set based on the scenario feature information update data.

5. An attack defense method for a terminal having a rich execution environment (REE) deployed on the terminal, the method comprising:
sending, by the REE, a communication request of a first client application (CA) for communication with a first secure application (TA), the communication request comprising current first scenario feature information corresponding to the first client application, the scenario feature information comprising any one or more of the following information: terminal screen touch information, terminal screen status information, and client application running information, the terminal screen touch information comprising any one or more of the following information: a quantity of taps on a terminal screen, a touch location on the terminal screen, and a manner of touching the terminal screen when the client application is operated, the terminal screen status information comprising any one or more of the following information: a terminal screen-on state and a terminal screen luminance value, and the client application running information is used to indicate whether the client application runs in the foreground; and
controlling a current operation of the first client application based on a status of communication between the first client application and the first secure application.

6. The method according to claim 5, wherein the controlling a current operation of the first client application based on a status of communication between the first client application and the first secure application comprises:
if communication is established between the first client application and the first secure application, allowing the current operation of the first client application.

7. The method according to claim 5, further comprising:
receiving, by the REE, scenario feature information update data from a network side; and
sending the scenario feature information update data to a secure execution environment.

8. A terminal, the terminal having a rich execution environment (REE) and a trusted execution environment (TEE) deployed on the terminal, the terminal comprising:
a processor; and
a memory, the memory configured to store a computer-executable instruction; wherein
when the processor executes the computer-executable instruction, the TEE performs
receiving, by a secure execution environment, a communication request of a first client application (CA) for communication with a first secure application (TA), wherein the secure execution environment comprises either or both of a TEE and a cloud security environment, and the communication request comprises current first scenario feature information corresponding to the first client application, wherein the scenario feature information comprises any one or more of the following information: terminal screen touch information, terminal screen status information, and client application running information, wherein the terminal screen touch information comprises any one or more of the following information: a quantity of taps on a terminal screen, a touch location on the terminal screen, and a manner of touching the terminal screen when the client application is operated, the terminal screen status information comprises any one or more of the following information: a terminal screen-on state and a terminal screen luminance value, and the client application running information is used to indicate whether the client application runs in the foreground; and
when the secure execution environment verifies the first scenario feature information, establishing, by the secure execution environment, communication between the first secure application and the first client application; and
the REE performs:
sending, by the REE, a communication request of a first client application for communication with a first secure application, wherein the communication request comprises current first scenario feature information corresponding to the first CA, wherein the scenario feature information comprises any one or more of the following information: terminal screen touch information, terminal screen status information, and client application running information, wherein the terminal screen touch information comprises any one or more of the following information: a quantity of taps on a terminal screen, a touch location on the terminal screen, and a manner of touching the terminal screen when the client application is operated, the terminal screen status information comprises any one or more of the following information: a terminal screen-on state and a terminal screen luminance value, and the client application running information is used to indicate whether the client application runs in the foreground; and
controlling a current operation of the first client application based on a status of communication between the first client application and the first secure application.
